(19) United States
(12) Patent Application Publication
(10) Pub. No.: US 2013/0112143 A1
(43) Pub. Date: May 9, 2013

(54) METHOD AND ARRANGEMENT FOR CONTROL OF THE MILKING

(71) Applicant: Ron Mulder, TeAroha (NZ)

(72) Inventor: Ron Mulder, TeAroha (NZ)

(73) Assignee: DELAVAL HOLDING AB, Tumba (SE)

(21) Appl. No.: 13/808,270

(22) PCT Filed: Jul. 5, 2011
(86) PCT No.: PCT/SE2011/050903

§ 371 Date: Jan. 4, 2013

(30) Foreign Application Priority Data
Jul. 8, 2010 (SE) 1050758-0
Jul. 8, 2010 (US) 61362372

(51) Int. Cl. A01J 5/00; A01K 15/04

(52) U.S. Cl. CPC A01J 5/007; A01K 15/04
USPC 119/14.02; 119/840; 119/14.08

(57) ABSTRACT

A method for control of milking of animals permitted to move within an area including at least one grazing paddock wherein the animals graze, a milking area located remote from the grazing paddock, and a raceway via which animals in the grazing paddock access the milking area, the milking area including a milking system for milking the animals that access the milking area. The animals that access the milking area via the raceway are counted in at least one position located remote from the milking system, a future amount of animals in the milking area is predicted based on the animals counted in the at least one position located remote from the milking system, and the operation of the milking system or other arrangement in the area is controlled in a manner and at a point of time based on the predicted future amount of animals in the milking area.

### TECHNICAL FIELD OF THE INVENTION

The present invention relates to a method and an arrangement for control of the milking of animals by a milking system.

### DESCRIPTION OF RELATED ART AND BACKGROUND OF THE INVENTION

Automatic milking systems (AMS) are well known in the art. The current implementations of AMS are almost entirely with housed cows. Cows are bedded and fed in a large barn that also houses the AMS. Cows learn to circulate freely the short distance between their cubicles and the AMS unit, a prime motivator being in-bail feeding while they are being milked in the AMS. The cows only need to move comparatively short distances, perhaps 20-30 m within the housing system to the AMS.

Many cows around the world are not housed in this fashion, however, but are allowed to freely graze on pastures. In Australia and New Zealand, in particular, there is no housing of cows; they spend all their time on pasture. These pasture-based systems are very extensive and often require the cows to walk considerable distances to be milked in conventional milking systems. This can be up to 2-3 km walking distance, and they normally do this twice a day.

Voluntary milking systems, which cows visit on a voluntary basis, have become increasingly common during the last years. In such systems cows are monitored and are given milking permission on an individual basis.

AU 2009202368 A1 discloses a system for management of animals which are allowed to move in an area intended therefore, wherein the area includes at least one grazing paddock in which the animals can graze, a milking area in which the animals are milked, and a waiting area, wherein the milking area and the waiting area are each accessible from the at least one grazing paddock, and the milking area is accessible from the waiting area. Hereby, animals which are almost qualified for milking can be kept in the waiting area during a shorter period of time before being milked in the milking area. If these animals would be redirected to grazing paddocks far away or if they were never allowed to reach the surroundings of the milking area, the probability that the animals would soon again visit the milking area is low, and as a result the milk production would be lower.

A rotary milking system comprises a rotary platform, which milking animals enter and leave in a sequential order in order to be milked. The rotary platform comprises a plurality of milking stalls, each provided with milking equipment for milking an animal present in the milking stall during rotation of the rotary platform. Recently, such rotary milking systems have been automated, wherein teat cups of the milking equipments are automatically attached to the teats of the animals to be milked by a robot arm provided with a gripper, see e.g. WO 2009/093964. One single robot arm may serve all or at least several milking stalls of the rotary milking system.

### SUMMARY OF THE INVENTION

The implementation of automated rotary milking systems for voluntary milking is not straightforward. The rotary milking system was originally developed for batch milking of animals, and requires typically a large number of animals to be milked concurrently with one another.

Particularly, during times of low traffic of animals to the milking area, the automated rotary milking system for voluntary milking seems to be an inefficient solution if no further measures are taken to improve efficiency.

While AU 2009202368 A1 discloses an automatic milking system for freely grazing animals that indeed will increase the throughput of animals through the milking system and thus increase milk production, there are many more measures to be taken in order to optimize productivity, in particular if rotary milking systems are to be used for voluntary or semi-voluntary milking of animals.

Similar limitations and drawbacks would be obtained in other types of milking systems arranged for voluntary or semi-voluntary milking of animals, particularly in those wherein a plurality of animals are milked concurrently with one another.

There is thus an object of the invention to provide a method and an arrangement for control of the milking of animals in a milking system arranged for voluntary milking of animals, particularly a milking system wherein a plurality of animals are milked concurrently with one another, such as e.g. a rotary milking system, which provide for improved efficiency of the milking production and thereby increased revenues.

It is a further object of the invention to provide such method and arrangement, which are robust, effective, fast, precise, accurate, reliable, safe, easy to use, and of reasonable cost.

These objects, among others, are according to the present invention attained by methods and arrangements in the appended patent claims.

According to a first aspect of the invention, a method is provided for control of the milking of animals which are allowed to move in an area intended therefore, wherein the area includes at least one grazing paddock in which the animals can graze, a milking area located remote from the grazing paddock comprising a milking system for milking of the animals which have accessed the milking area, and a raceway via which animals in the grazing paddock can access the milking area. According to the method animals that are to access the milking area via the raceway are counted in at least one position located remote from the milking system; a future amount of animals in the milking area is predicted based on the animals counted in the at least one position located remote from the milking system; and the operation of the milking system or other arrangement in the area is controlled in a manner and at a point of time which is dependent on the predicted future amount of animals in the milking area. Such other arrangement may e.g. be a gate arrangement, an animal treatment device, a feed supply device, or a water supply device. By such provisions the predicted future amount of animals in the milking area becomes a parameter which affects how and when a control of the milking system or other arrangement in the area is effected.

Preferably, the counted animals are animals that have already achieved permission to be milked in the milking system. Hereby it can be established already at the remote position when an animal is going to be milked.

In one embodiment, the animals that are to access the milking area via the raceway are counted in a plurality of positions and the future amount of animals in the milking area is predicted based also on the animals counted in the plurality of positions. Hereby, the prediction can be made more accurate and precise. Preferably, the counters are arranged such that the same animal is counted at more than one position during its walk to the milking area. Hereby, the prediction can be made more accurate and precise, the closer the animal comes to the milking area.

The prediction may at each position be made dependent on the distance to the milking area and/or on previous actual times for the animal to move to the milking area.

The milking system may be a milking system wherein a plurality of animals are milked concurrently with one another, particularly a rotary milking system.

The manner in which the milking system is controlled may comprise to initiate a milking session by the milking system dependent on the predicted future amount of animals in the milking area. In particular, the milking session by the milking system may be initiated at a future point of time, which is related to the point of time at which the predicted future amount of animals in the milking area is above a threshold value, which is preferably based on the revenues of the repeatedly determined accumulated expected milk yield and the costs for operating the milking system. Hereby, the milk production can be improved in terms of reduced operation costs.

According to a second aspect of the invention, a method is provided for control of the milking of animals which are allowed to move in an area intended therefore, wherein the area includes at least one grazing paddock in which the animals can graze, a milking area located remote from the grazing paddock comprising a milking system for milking of the animals which have accessed the milking area, and a raceway via which animals in the grazing paddock can access the milking area. According to the method, each of the animals that is to access the milking area is identified in at least one position located remote from the milking system and, for each of the identified animals, an expected milk yield obtainable in milking that animal is determined. Next, a future amount of animals in the milking area is predicted based on the animals identified in the at least one position located remote from the milking system, and a future accumulated expected milk yield obtainable in milking the predicted future amount of animals is predicted based on the predicted future amount of animals in the milking area and their expected milk yields. Finally, the operation of the milking system or other arrangement in the area is controlled in a manner and at a point of time which is dependent on the future accumulated expected milk yield.

Hereby, an improved method is obtained which further improves milk production. Not only the predicted future number of animals in the milking area is taken into account, but also their expected future milk yields.

The expected milk yield obtainable in milking an animal is preferably determined based on previously collected data regarding that animal, wherein the data may include any of previous milk yields, previous milking times, and previous times lapsed between milkings of that animal.

According to a third and a fourth aspect of the invention, control arrangements are provided by which the control methods of the first and second aspects of the invention can be implemented. One control arrangement comprises at least one animal counting device for the counting and process and control devices operatively connected to the animal counting device for performing the steps of counting animals, predicting a future amount of animals in the milking area, and controlling the operation of the milking system or other arrangement in the area in a manner and at a point of time which is dependent on the predicted future amount of animals in the milking area. The other control arrangement comprises at least one animal identification device for the identifications, and process and control devices operatively connected to the animal identification device for performing the steps of identifying animals, determining milk yields, predicting a future amount of animals in the milking area, predicting a future accumulated expected milk yield, and controlling the operation of the milking system or other arrangement in the area in a manner and at a point of time which is dependent on the predicted future accumulated expected milk yield.

According to a fifth and a sixth aspect of the invention, computer program products are provided which are loadable into the internal memory of a computer of an animal handling arrangement and comprise software code portions for performing the control methods of the first and second aspects of the invention when the computer program products are run on the computer.

Further characteristics of the invention, and advantages thereof, will be evident from the detailed description of embodiments of the present invention given hereinafter and the accompanying FIGS. 1-3, which are given by way of illustration only, and thus are not limitative of the present invention.

### BRIEF DESCRIPTION OF THE DRAWINGS

FIG. 1 illustrates schematically an arrangement for housing animals and a control arrangement in accordance with an embodiment of the invention implemented in the arrangement.

FIG. 2 illustrates schematically an enlarged portion of the arrangement of FIG. 1.

FIG. 3 is a flow scheme of a control method in accordance with an embodiment of the invention.

### DETAILED DESCRIPTION OF EMBODIMENTS

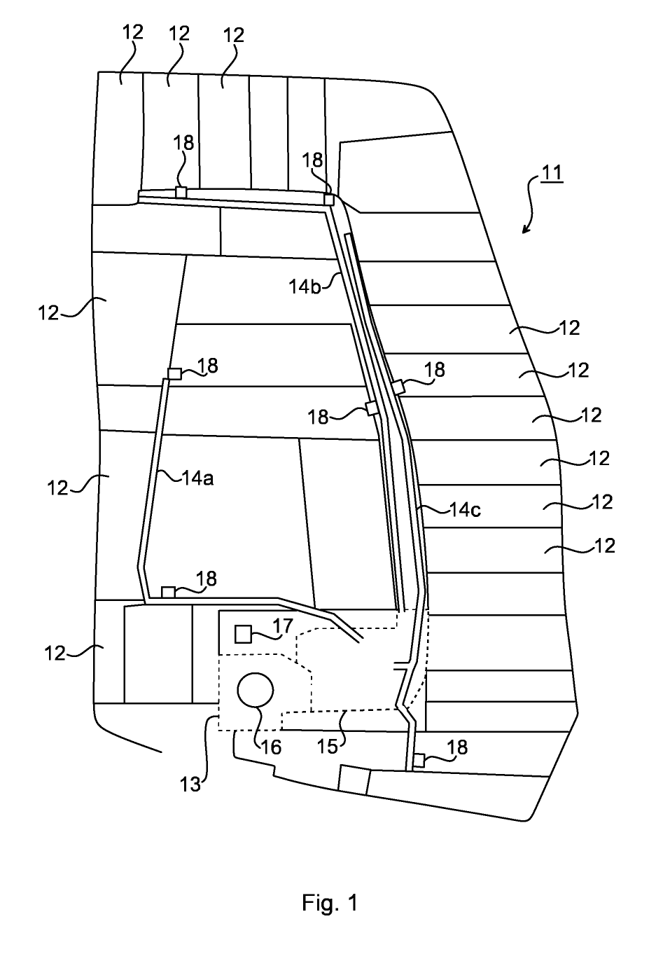

FIG. 1 illustrates schematically a pasture based animal arrangement for housing animals which are allowed to move in an area 11 thereof. The area 11 comprises preferably a large number of grazing pastures 12, in which the animals can graze, a milking area 13 located remote from the grazing paddocks 12, and various raceways 14a-c and a pre- and postmilking area 15, via which the animals in the grazing paddocks 12 can access the milking area 13 and vice versa. The milking area 13 comprises a rotary milking system 16, preferably for voluntary or semi-voluntary milking of the animals which have accessed the milking area 13 in a milking session. It shall, however, be apparent to a skilled person that the invention may be implemented in other kinds of milking systems, particularly in those wherein a plurality of the animals are milked concurrently with one another.

The pasture based animal arrangement comprises further preferably a plurality of animal counting or identification devices 18 arranged in the various raceways 14a-c at different distances from the milking area 13, each for counting and optionally identifying an animal passing that animal identification device 18.

In one embodiment, an animal counting or identification device is arranged at the entry/exit of each of the grazing paddocks 12 to monitor the number and optionally identities of the animals that enter and exit the grazing paddock 12. In case these devices are animal identification devices, each of the entries/exits may be provided with a gate arrangement operatively connected to the animal identification device arranged at that entry/exit for only allowing an animal to enter/exit that grazing paddock after having been identified, and optionally only in the event the identified animal fulfils some kind of criterion. Animals can thus be counted and identified at the respective grazing paddock 12 before being allowed to enter the respective raceway 14a-c and again be counted and optionally identified when passing an animal counting or identification device 18 in the respective raceway 14a-c.

A process and control device 17 is operatively connected to each animal counting or identification device 18 for receiving counts and optionally identifications, optionally to each gate arrangement for the control thereof, and to the rotary milking system 16 for the control thereof.

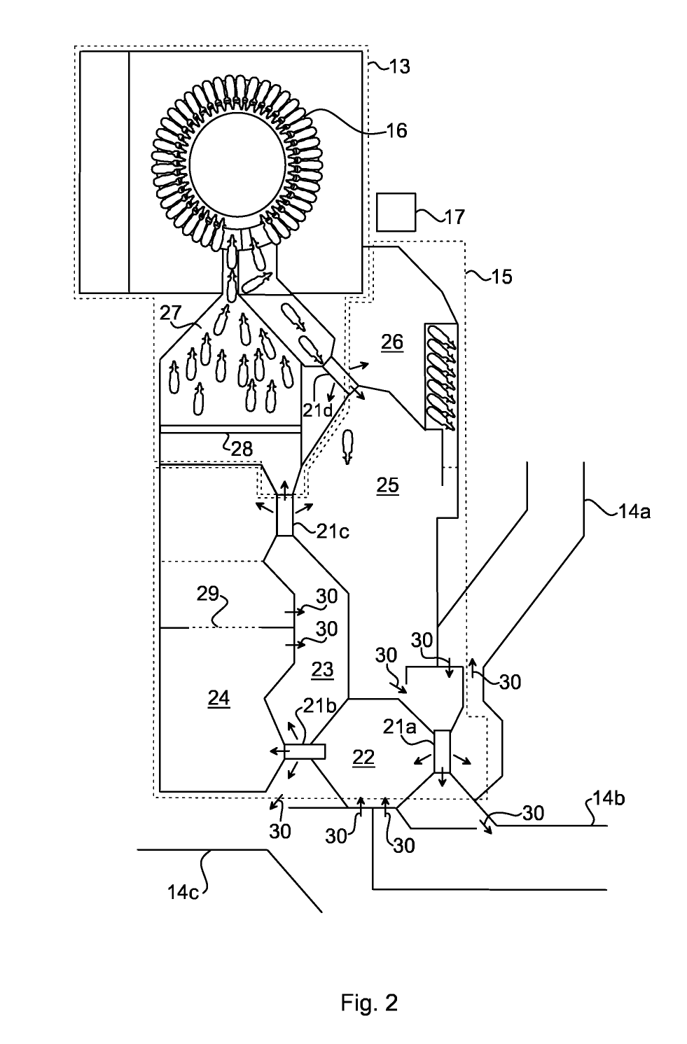

With reference next to FIG. 2, which illustrates schematically an enlarged portion of the area of FIG. 1, there is provided four selection boxes 21a-d, two 21a-b of which animals may have to pass to enter the pre- and postmilking area 15 from the various raceways 14a-c, one 21c of which animals have to pass to enter the milking area 13 from the pre- and postmilking area 15, and one 21d of which animals have to pass after having been milked by the rotary milking system 16. Each of the selection boxes 21a-d has one entry, and is provided with an animal identification device for identification of the animal entering the selection box 21a-d, and is operatively connected to the process and control device 17 for control. Each of the selection boxes 21a-d has three exits wherein each animal can be allowed, guided, or forced to exit either one of the three exits after having been identified and depending on one or several criteria. The pre- and postmilking area 15 comprises different enclosed areas 22-26, and the milking area 13 comprises a gathering area 27 and an automatic backing gate 28 operatively connected to the process and control device 17 for forcing animals in the gathering area 27 towards the rotary milking system 16.

An animal that walks the raceway 14a towards the pre- and postmilking area 15 reaches a first selection box 21a. The animal is identified and depending on one or several criteria, the animal is allowed to enter area 22, to enter raceway 14b, or to re-enter raceway 14a. In the two latter instances, the animal is guided back to a grazing paddock that can be accessed via any of raceways 14b, 14a. This may be desirable if the animal has no milking permission and should not be treated.

If the animal enters area 22, it then reaches a second selection box 21b. The animal is again identified and depending on one or several criteria, the animal is allowed to enter area 23, area 24, or raceway 14c. In the latter instance, the animal is guided back to a grazing paddock that can be accessed via raceway 14c. Area 24 is a waiting area or a treatment area, wherein the animal is guided if e.g. it is almost qualified for milking or if it is to be treated before milking. Area 24 may offer feed, water, and/or rest to the animal.

If the animal enters area 23, it then reaches a third selection box 21c. The animal is again identified, and depending on one or several criteria the animal is allowed to enter area 24, gathering area 27 of the milking area 13, or area 25. Area 24 may be divided into two separate portions by a wall, fence, or similar at 29, and thereby the animal can be guided to either portion by the second and third selection boxes 21b and 21c. Area 25 is a postmilking area 25 which may offer feed, water, and/or rest to the animal. The postmilking area 25 leads back to the first selection box 21a. By means of the first selection box 21a and optionally the second and/or third selection boxes 21b and 21c, the animal can be guided back to a grazing paddock via any of the raceways 14a-c or to any of the portions of the area 24.

If the animal is qualified for milking and should not wait for some reason, e.g. being treated, it is allowed to enter the gathering area 27 of the milking area 13 to be milked in the rotary milking system 16 in a milking session.

The rotary milking system 16 comprises in a conventional manner a rotary platform which animals preferably enter and leave in a sequential order in order to be milked. The rotary platform comprises a plurality of milking stalls, each provided with milking equipment for milking an animal present in the milking stall. The rotary platform rotates with the milking stalls, and the animals which have entered the rotary platform, so that each animal has been entirely milked when the animal has been rotated almost one full revolution. The rotary milking system 16 may be automatic, wherein teat cups of the milking equipments are automatically attached to the teats of the animals to be milked by a robot arm provided with a gripper, see e.g. WO 2009/093964, the contents of which being hereby incorporated by reference.

After milking, the animal enters the fourth selection box 21d. The animal is identified, and depending on one or several criteria the animal is allowed to enter postmilking area 25, the gathering area 27 of the milking area 13, or area 26. The animal may be guided back to the gathering area 27 of the milking area 13 if e.g. it was not appropriately milked for some reason. Area 26 is a further waiting area or a treatment area, and animals collected in this area may eventually be led to the postmilking area 25 and be guided to a grazing paddock or elsewhere. Area 26 may offer feed, water, and/or rest to the animal.

The traffic direction of animals in the pre- and postmilking area 15, the milking area 13, and in the ends of the raceways 14a-c is indicated by arrows 30. In order to obtain the illustrated traffic direction, a number of one-way gates may be provided, which can be opened by the animal, by an operator, or automatically under control of the process and control device 17. In particular, the gates that lead animals from the portions of area 24 back to area 23 may be provided with identification devices such that selected animals may be allowed to enter area 23 from area 24 after having been identified.

It shall, however, be appreciated by the skilled person that the pre- and postmilking area 15 and optionally the milking area 13 may be designed differently. The pre- and postmilking area 15 may even be dispensed with and the milking area 13 may only include a rotary milking system 16.

The present invention relates to an arrangement for control of the milking of animals by the rotary milking system 16. In its simplest embodiment the arrangement comprises at least one animal counting device 18 and the process and control device 17. The animal counting device 18 is provided for counting animals that, via a raceway, are to access the milking area 13 to be milked by the rotary milking system 16. The process and control device 17 is arranged to predict a future amount of animals in the milking area 13 based on the animals counted by the animal counting device 18. Finally, the process and control device 17 is arranged to control the operation of the rotary milking system 16 in a manner and at a point of time which is dependent on the predicted future amount of animals in the milking area 13. Alternatively, or additionally, the operation of other arrangement in the area 11 is controlled in a manner and at a point of time which is dependent on the predicted future amount of animals in the milking area 13. Such other arrangement may comprise any of a gate arrangement, a selection box such as any of the selection boxes 21a-d, an animal treatment device, a feed supply device, or a water supply device.

Preferably, the inventive arrangement comprises a plurality of animal counting devices 18 located in a plurality of positions remote from the rotary milking system 16 arranged to count animals that are to access the milking area 13 via the raceway, and the process and control device 17 is provided for predicting the future amount of animals in the milking area 13 based on the animals counted in the plurality of positions.

Hereby, not only the number of animals that actually are present in the milking area 13 are taken into account in the control of the operation of the rotary milking system 16 or the other arrangement, but also the number of animals that are predicted to be in the milking area 13 in the future are taken into account.

More in detail, the future amount of animals in the milking area may be calculated from predicted arrival times, and these may, for each counted animal, be predicted based on the distance from the milking area to the position where it was counted, or on an expected time for moving from the position where it was counted to the milking area, based on previous actual times for the animal to move from the position where it was counted to the milking area 13.

That is, each of the animal counting devices 18 of the inventive arrangement is associated with an estimated time, at which animals counted by that animal counting device 18 is predicted to arrive at the milking area 13. For example, the most remotely located animal counting devices 18 may be associated with an arrival time of 30 minutes after the time when an animal was counted, other more closely located animal counting devices 18 may be associated with an arrival time of 20 minutes after the time when an animal was counted, other yet more closely located animal counting devices 18 may be associated with an arrival time of 10 minutes after the time when an animal was counted, and other animal identification devices 18 in close vicinity of the milking area 13 may be associated with an arrival time of 1, 2 or 5 minutes after the time when an animal was counted.

The future amount of animals in the milking area 13 is then predicted, for each future time instant, by simply counting the number of animals that have expected arrival times before that time instant. Hereby, the future amount of animals in the milking area 13 can be predicted for one or several selected future points of time.

It shall be appreciated that animal counting devices of the inventive arrangement may be located within the pre- and postmilking area 15 as well as at each entry/exit of each grazing paddock 12. The animal counting devices of the inventive arrangement may also be located such that each or some of the animals has/have to pass just one or has/have to pass several ones of the animal counting devices. In the latter instance, if some animals pass two animal counting devices and other animals pass only the last one of these, depending on the locations of the grazing paddocks 12, and if no identifications are made, it may be difficult to determine whether an animal counted at the last animal counting device is an animal that has already passed the previous animal counting device, or a new animal in the raceway. However, by means of analysis of the time points of the countings, and knowledge of walking speeds, it can be determined if the animal is most likely an animal that has already passed the previous animal counting device, or a new animal in the raceway.

In a more sophisticated approach, wherein the inventive arrangement comprises one or more animal identification devices 18, the future amount of animals in the milking area may be predicted based on previous actual times for the animal to move from the position where it was identified to the milking area 13. For the example above, each position for animal identification is given an expected arrival time on an animal individual level.

The manner in which the control of the operation of the rotary milking system 16 is effected, which is dependent on the predicted future amount of animals in the milking area, may comprise to initiate a milking session by the rotary milking system 16. Such initiation may include to start moving the automatic backing gate 28 towards the rotary milking system 16, to start rotating the rotating platform of the rotary milking system, and/or to allow a first one of the animals to be milked to enter a milking stall of the rotating platform.

The milking session by the rotary milking system 16 may be initiated at a future point of time, which is related to the point of time at which the predicted future amount of animals in the milking area is above a threshold value, wherein the threshold value can be related to the number of milking positions of the rotary milking system 16. Different rotary milking systems may have different preparation times, the collection of the animals in the gathering area 27 of the milking area may take different times depending on the design of the automatic backing gate 28, teat attachment may take different times, etc. Hereby, it cannot be established exactly when a particular operation should be initiated. However, by means of the inventive predictions of the future amount of animals in the milking area, a skilled person can design the control of the operation of the rotary milking system 16 to optimize milk production revenues.

By means of the present invention, it can thus be controlled exactly how a milking session by the rotary milking system 16 should be controlled in order to achieve an optimum milk production in terms of revenues of produced milk versus its producing costs.

It shall be appreciated that in some situations, e.g. if it is not healthy for an animal not to be milked (if the animal has waited for milking for such a long time that this presents a health risk) or if an animal for some reason urgently has to be guided to area 26, which can only be reached via the rotary milking system 16, a milking session may be initiated in order to milk that animal irrespective of the predicted future amount of animals in the milking area, in order to maintain good animal health. Alternatively, an operator is alerted.

The manner in which the control of the operation of the rotary milking system 16 or other arrangement in the area is effected, which is dependent on the predicted future amount of animals in the milking area, may comprise to guide an animal to the waiting area or treatment area 24 by any of the selection boxes 21b or 21c, to treat an animal in the waiting area or treatment area 24 or elsewhere by an automatic animal treatment device, to offer feed to an animal in the waiting area or treatment area 24 or elsewhere by an automatic feed supply device, and/or to offer water to an animal in the waiting area or treatment area 24 or elsewhere by an automatic water supply device. That is, an animal can be guided to the waiting area or treatment area 24 at points of time when the predicted future amount of animals in the milking area is too low to initiate a milking session. The treatment of an animal may be performed at a point of time when the predicted future amount of animals in the milking area is low, particularly if the treatment is non-urgent. Also feed and water can be offered at points of time when the predicted future amount of animals in the milking area is low. On the other hand, animals in the waiting area or the treatment area can be guided to the milking area at points of time when the predicted future amount of animals is high (and when it is anticipated that milking soon will begin).

Thus, it can be concluded that the milking system and also various other arrangements in the area can be controlled dependent on the predicted future amount of animals in the milking area. Not only how the control is effected, but also when it is effected, depends on the predicted future amount of animals in the milking area. While various examples are given above, a person skilled in the technical field may find different control procedures, which advantageously are performed using the present invention. This far an inventive arrangement has been disclosed which takes into account the predicted future number of animals in the milking area 13. However, the invention encompasses also an embodiment which is more sophisticated. Here, each remotely located animal counting device 18 of the above disclosed inventive arrangement is an animal identification device 18 arranged to identify each of the animals that is to access the milking area 13. The process and control device 17 is not only arranged to predict a future amount of animals in the milking area 13 based on the animals identified by the remotely located animal identification device(s) 18, but is also arranged to determine, for each of the identified animals, an expected milk yield obtainable in milking that animal and to predict a future accumulated expected milk yield obtainable in milking the predicted future amount of animals based on the predicted future amount of animals in the milking area and their expected milk yields. Finally, the process and control device 17 is not arranged to control the operation of the rotary milking system 16 at a point of time which is dependent on the predicted future amount of animals in the milking area 13, but on the future accumulated expected milk yield.

Preferably, for each of the identified animals, the expected milk yield obtainable in milking that animal is determined based on previously collected data regarding that animal, which may include any of previous milk yields, previous milking times, and previous times lapsed between milkings of that animal.

In the prediction of the future amount of animals in the milking area 13, the animal identification device of the third selection box 21c, which animals have to pass to enter the milking area 13 from the pre- and postmilking area 15, may be used to identify the animals that actually enter the milking area 13, and correlate the arrival times of those animals with the predicted arrival times.

The animal identification devices of the selection boxes 21a-d, as well as other animal identification devices in the area 11, may be part of the inventive arrangement in order to obtain more accurate and precise predictions of milking area arrival times.

In the determination of the future accumulated expected milk yield, the expected milk yields of the predicted future amount of animals in the milking area may be added. However, account may be taken to the milk production by each of the predicted future amount of animals in the milking area between the time of predicting the expected milk yield for that animal, and the future time for which the prediction of the future accumulated expected milk yield is made. The expected milk production may be determined based on previously collected data regarding that animal or regarding a group of animals.

Hereby, not only the number of animals that are predicted to be in the milking area 13 in the future are taken into account in the control of the operation of the rotary milking system 16, but also their expected future milk yields are taken into account. A more accurate and precise prediction of the future accumulated milk yield can be made.

Preferably, the rotary milking system 16 is controlled in a manner such that a milking session is initiated. This is effected at a point of time which is related to the point of time when the revenues of the future accumulated expected milk yield are expected to be higher than the costs for operation of the rotary milking system 16.

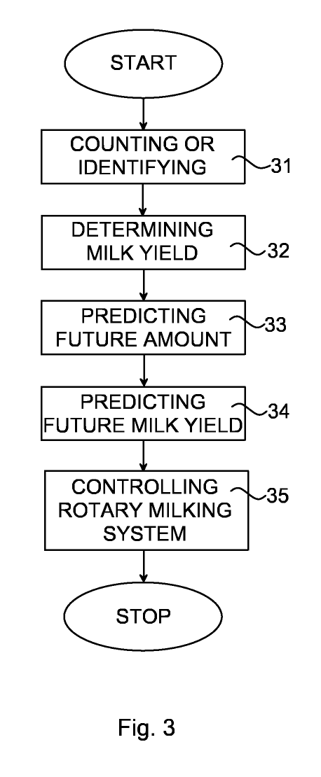

FIG. 3 is a flow scheme of a method for control of the milking of animals which are allowed to move in an area intended therefore, wherein the area includes at least one grazing paddock in which the animals can graze, a milking area located remote from the grazing paddock comprising a rotary milking system for milking of the animals which have entered the milking area, and a raceway via which animals in the grazing paddock can enter the milking area, i.e. a method for control of the milking of animals in a animal arrangement such as e.g. the animal arrangement of FIG. 1.

According to the method, each of the animals that are to access the milking area via the raceway are, in a step 31, counted and optionally identified in at least one position located remote from the rotary milking system. If each animal is identified, an expected milk yield obtainable in milking that animal is, in a step 32, predicted. Next, a future amount of animals in the milking area is, in a step 33, predicted based on the animals counted or identified in the at least one position located remote from the rotary milking system. If an expected milk yield obtainable in milking each animal is predicted, a future accumulated expected milk yield obtainable in milking the predicted future amount of animals is, in a step 34, predicted based on the expected milk yields of the identified animals. This may be done simply by adding the expected milk yields of the identified animals. However, a more sophisticated approach is to take into account milk production by the identified animals from current time to a future time, for which the prediction is made. Finally, the operation of the rotary milking system is, in a step 35, controlled in a manner and at a point of time which is dependent on the predicted future amount of animals in the milking area.

The control of the rotary milking system is preferably effected in a manner such that a milking session is initiated. This is effected at a point of time when the revenues of milk obtained in the milking by the rotary milking system are expected to be higher than the costs for operating the rotary milking system.

The invention encompasses also a rotary milking system comprising any of the inventive arrangements disclosed above.

Further, a computer program product loadable into the internal memory of a computer of an animal handling arrangement is claimed, comprising software code portions for carrying out any of the inventive control methods disclosed above when the computer program product is run on the computer.

It shall be appreciated that the grazing paddocks 12 may be of a much higher number, may be of different shapes, or may be located in different patterns. Further, the raceways 14a-c and the gate arrangements/selection boxes 21a-c may be located and designed differently or may be dispensed with. Still further, the process and control device of the invention may be a separate device from a centralized process and control device which is responsible for the overall control of the animal arrangement.

It shall further be appreciated that the inventive arrangement and method can be implemented in animal arrangements comprising a milking area with other kind of milking systems, particularly automated milking systems, semi-automated milking systems, voluntary milking systems, semi-voluntary milking systems, milking systems wherein a plurality of milking systems are milked concurrently with one another, or any combinations thereof.

It shall yet further be appreciated that the various aspects and embodiments of the invention as disclosed above may be combined in a plurality of manners. The scope of protection of the present invention is only given by the following claims.

1-20. (canceled)

21. A method for control of milking of animals permitted to move in an area (11) intended therefore, said area (11) including at least one grazing paddock (12) in which the animals can graze, a milking area (13) located remote from the grazing paddock, and a raceway (14a-c) via which animals in the grazing paddock can access the milking area (13), the milking area having a milking system (16) therein for milking of animals that have moved to the milking area, the method comprising the steps of:
counting animals (31) at at least one position (18) that is remote from the milking area (13) and from which the milking area (13) is accessible by the animals via the raceway (14a-c);
predicting (33) a future amount of animals in the milking area based on animals counted at the at least one position (18) located remote from the milking system (16); and
controlling (35) an operation of at least one system that administers to animals in the milking area (13) in a manner and at a point of time which is dependent on the predicted future amount of animals in the milking area (13).

22. The method of claim 21, wherein the counted animals are animals that have achieved permission to be milked.

23. The method of claim 21, wherein animals that are to access said milking area (13) via the raceway (14a-c) are counted in a plurality of said positions (18), and the predicted future amount of animals in the milking area is predicted based on the animals counted at the plurality of said positions (18).

24. The method of claim 21 wherein the future amount of animals is predicted based on a distance of each counted animal from the at least one counting position (18) to the milking area (13).

25. The method of claim 24, wherein the future amount of animals is also predicted based on an expected time for moving from the at least one counting position (18) to the milking area (13).

26. The method of claim 25, wherein each animal counted at the at least one counting position (18) is identified, and the expected time for moving from the at least one counting position (18) to the milking area (13) is determined based on previous actual times for the animal to move from the at least one counting position (18) to the milking area (13).

27. The method of claim 21 wherein the future amount of animals in the milking area is predicted for a plurality of selected future points of time.

28. The method of claim 21, further comprising:
using a milking system configured to milk a plurality of animals concurrently with one another,
wherein the controlling step comprises initiating a milking session by the milking system in a manner and at a point of time which is dependent on the predicted future amount of animals in the milking area (13).

29. The method of claim 28 wherein the controlling step initiates the milking session of the milking system (16) at a future point of time based on a point of time at which the predicted future amount of animals in the milking area (13) is above a threshold value.

30. The method of claim 29 wherein said threshold value is based on a number of milking positions of said milking system (16).

31. The method of claim 21, wherein animals counted at the at least one counting position (18) that are to access said milking area via the raceway (14a-c) are first received in a waiting area (15) in which they are offered feed, water, and/or rest, and are thereafter, at a point of time dependent on the predicted future amount of animals in the milking area, permitted to access the milking system (16).

32. A computer program product, recorded on a non-transitory computer-readable recording medium, loadable into an internal memory of a computer (17) of a milking system, comprising software code configured to cause the computer (17) to implement the method as claimed in claim 21.

33. An arrangement for control of milking of animals permitted to move in an area (11) intended therefore, said area (11) including at least one grazing paddock (12) in which the animals can graze, a milking area (13) located remote from the grazing paddock, and a raceway (14a-c) via which animals in the grazing paddock can access the milking area (13), the milking area including a milking system (16) for milking animals that have moved to the milking area (13), the arrangement comprising:
at least one animal counter (18) located at a position remote from the milking system (16) and from which the milking area (13) is accessible by the animals via the raceway (14a-c), the at least one animal counter (18) configured to count animals that are to access said milking area (13) via the raceway (14a-c); and
a process and control device (17) operatively connected to the at least one animal counter (18) and configured to (i) predict a future amount of animals in the milking area (13) based on animals counted at the at least one position (18) located remote from the milking system (16), and (ii) control operation of at least one system that administers to animals in the milking area (13) in a manner and at a point of time which is dependent on the predicted future amount of animals in the milking area (13).

34. The arrangement of claim 33,
wherein a plurality of said animal counters (18) are respectively located at a plurality of positions remote from the milking system (16), each configured to count the animals that are to access said milking area (13) via the raceway (14a-c), and
wherein the process and control device (17) is operatively connected to each of the plurality of animal counters (18) and is configured to predict the future amount of animals in the milking area based on the animals counted at the plurality of positions.

35. The arrangement of claim 33,
wherein the milking system (16) located in the milking area (13) is configured to milk a plurality of animals concurrently with one another,
wherein said process and control device is operatively connected to the milking system (16) and is configured to initiate a milking session by the milking system (16) at a point of time based on the predicted future amount of animals in the milking area (13).

36. A method for control of milking animals permitted to move in an area (11) intended therefore, said area including at least one grazing paddock (12) in which the animals can graze, a milking area (13) located remote from the grazing paddock, and a raceway (14a-c) via which animals in the grazing paddock can access the milking area (13), the milking area including a milking system (16) for milking animals that have moved to the milking area (13), the method comprising the steps of:
identifying (31) animals that are to access said milking area (13) via the raceway (14a-c) at at least one position located remote from the milking system (16);
determining (32), for each animal identified in said identifying step, an expected milk yield obtainable in milking the identified animal;
predicting (33) a future amount of animals in the milking area (13) based on the animals identified in the identifying step at the at least one position;
predicting (34) a future accumulated expected milk yield based on the predicted future amount of animals in the milking area (13) and the determined expected milk yields for each animal; and
controlling (35) an operation of at least one system that administers to animals in the milking area (13) in a manner and at a point of time which is dependent on the future accumulated expected milk yield.

37. The method of claim 36 wherein, for each of the identified animals, the expected milk yield obtainable in milking is determined based on previously collected data regarding the identified animal.

38. The method of claim 37, wherein the previously collected data includes any of previous milk yields, previous milking times, and previous times lapsed between milkings of the identified animal.

39. A computer program product, recorded on a non-transitory computer-readable recording medium, loadable into the internal memory of a computer (17) of a milking system, comprising software code configured to cause the computer (17) to implement the method as claimed in claim 36.

40. An arrangement for control of the milking of animals permitted to move in an area (11) intended therefore, said area (11) including at least one grazing paddock (12) in which the animals can graze, a milking area (13) located remote from the grazing paddock, and a raceway (14a-c) via which animals in the grazing paddock can access the milking area (13), the milking area including a milking system (16) for milking animals that have moved to the milking area (13), the arrangement comprising:
at least one animal identification device (18) located at a position remote from the milking system (16) and from which the milking area (13) is accessible by the animals via the raceway (14a-c), that at least one animal identification device (18) configured to identify animals that are to access said milking area via the raceway (14a-c); and
a process and control device (17) operatively connected to the at least one animal identification device (18) and configured to:
determine, for each identified animal, an expected milk yield obtainable in milking the identified animal;
predict a future amount of animals in the milking area (13) based on a count of the identified animals;
predict a future accumulated expected milk yield obtainable based on the predicted future amount of animals in the milking area and the determined expected milk yields for each animal; and
control the operation of at least one system that administers to animals in the milking area (13) in a manner and at a point of time which is dependent on the future accumulated expected milk yield.

41. The method of claim 21, wherein the at least one system comprises any of a gate arrangement, an animal treatment device, a feed supply device, and a water supply device.

42. The arrangement of claim 33, wherein the at least one system comprises any of a gate arrangement, an animal treatment device, a feed supply device, and a water supply device.

43. The method of claim 36, wherein the at least one system comprises any of a gate arrangement, an animal treatment device, a feed supply device, and a water supply device.

44. The method of claim 36, wherein the controlling step controls an operation of the milking system (16) in a manner and at a point of time which is dependent on the future accumulated expected milk yield.

45. The arrangement of claim 40, wherein the at least one system comprises any of a gate arrangement, an animal treatment device, a feed supply device, and a water supply device.

46. The arrangement of claim 40, wherein the process and control device controls an operation of the milking system (16) in a manner and at a point of time which is dependent on the future accumulated expected milk yield.
